(19) United States
(12) Patent Application Publication
(10) Pub. No.: US 2005/0170317 A1
(43) Pub. Date: Aug. 4, 2005

(54) Shine time - gold tooth polish

(76) Inventor: Auska Garrett, Kansas City, KS (US)

Correspondence Address: Auska Garrett, 2500 North 44th Street, Kansas City, KS, 66102, US

(21) Appl. No.: 10/968,217

(22) Filed: Oct. 19, 2004

Related U.S. Application Data
(60) Provisional application No. 60/512,451, filed on Oct. 20, 2003.

(51) Int. Cl. A61C 15/00

(52) U.S. Cl. 433/216

(57) ABSTRACT

This product is designed for human usage. For the shining and polishing of Dental Cosmetics such as gold and Platinum. This product is also designed for anyone with precious metals fixed to their denture or partials. Product Ingredients Calcium Carbonate, Water, Emulsifiers/Gums Flavorings including Peppermint, Spearment Cinnamon, Lemon, Lime, Orange and Licorice

### CROSS REFERENCE TO RELATED APPLICATIONS

This application claims the benefit of Provisional Patent Application Application No.: 60/512,451, filed Oct. 20, 2003 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to gold tooth polish, specifically to cleaning and polishing permanent and removable human teeth adorned with gold inlays and gold crowns.

2. Prior Art

Whether by choice or necessity, people old and young, wear dental gold on their natural and artificial teeth.

At times, people have suffered injuries to their natural teeth due to automobile, sporting, household, and childhood accidents, and either lost natural teeth or damaged natural teeth.

The inventor first suffered damage to one of his teeth more than 30 years ago, while an adolescent, rather than having the damaged tooth removed, the inventor chose to have a gold crown applied.

At times, people have suffered dental disease and decay, and as a result have lost some of their natural teeth or tooth surfaces.

Entertainers choosing to enhance their physical image and facial appearance adorn their teeth with gold, which emits gleam and shine to their fans.

Young people choosing to enhance their physical appearance in order to attract and keep friends and the opposite sex adorn their teeth with shining and sparkling gold teeth.

People who are fans of entertainers choose to copy their role models and idols by adorning their teeth with gold as a tribute to their favorite entertainers.

Some dental gold is permanently fixed to the natural teeth in the mouths of persons young and old, as crowns.

Some dental gold is partially fixed to the natural teeth of persons young and old, with stainless steel wires or the like, and removable as partial plates.

Some dental gold is clipped onto the natural teeth of persons for special occasions in order to change their appearance for a special moment.

Some dental gold is permanently fixed to dentures.

Whether permanent, partial, or clipped onto the teeth, some diamonds or other precious gems are encased into dental gold.

For more than 6 years, the inventor has sought gold polish products that would commonly be supplied by dental offices, medical offices, pharmacies, jewelry stores, department stores, specialty stores, or the like to not only clean but also shine dental gold, however, has found none.

The inventor has sought gold polish products that were safe for human consumption and/or introduction into the oral cavity of human beings, that not only cleans but also shines dental gold, that would commonly be supplied by, dental offices, medical offices, pharmacies, jewelry stores, department stores, specialty stores, or the like, however, has found none.

Some persons utilize harsh and possibly toxic chemicals (introducing the chemicals into the mouth and oral cavity) in order to shine their dental gold, including: brass polish products, and jewelry cleaner products. The usage of such chemicals may be costly economically as well as may contribute to ill health in humans.

Some persons utilize baking soda products and toothpaste products, which, are safe for human consumption, in order to clean their dental gold, however, such products may not offer a shine or gleam to the dental gold. Though such household products can be relatively inexpensive, the full job may not be done if the person cannot obtain the gold tooth shine they desire.

Some persons utilize dry jeweler's buffing cloths, without any other solution in order to shine their dental gold, however, may not be able to clean the dental gold. Though such method may be inexpensive, the jeweler's buffing cloth may not be safe for introduction into the mouth and oral cavity.

Some persons utilize machines including jeweler's buffing machines in order to shine their gold inlayed or gold crown partial plates and dentures. This process may not be safe for the dental work, and it may also be expensive if the dental work is damaged by the machine. Further, jeweler's buffing machines may not be a healthy choice for introduction into the mouth or oral cavity.

### OBJECTS AND ADVANTAGES

Accordingly, several objects and advantages of my invention are:
(a) to provide a safe product for human consumption or introduction into the mouth and oral cavity.
(b) to provide an inexpensive gold tooth polish readily available to anyone with dental gold on their natural teeth.
(c) to provide an inexpensive gold tooth polish readily available to anyone with dental gold on the teeth of their partial plates.
(d) to provide an inexpensive gold tooth polish readily available to anyone with dental gold on the teeth of their dentures.
(e) to provide an inexpensive gold tooth polish readily available to anyone with clip-on dental gold on the teeth.
(f) to provide a gold tooth polish readily available to entertainers to enhance the gleam and shine of their gold teeth.
(g) to provide an inexpensive gold tooth polish readily available to fans of entertainers to enhance the shine of their dental gold.
(h) to provide a gold tooth polish that is not harmful to precious gems, including diamonds, which are encased in dental gold.
(i) to provide a gold tooth polish readily available to anyone in dental offices, medical offices, pharmacies, jewelry stores, department stores, specialty stores, or the like.
(j) to provide an inexpensive gold tooth polish readily available to anyone wanting to avoid introduction of possible toxic chemicals into their mouth or oral cavity from chemicals such as brass polishes and jewelry cleaners.
(k) to provide an inexpensive gold tooth polish available to anyone wanting to clean as well as shine their gold teeth.
(l) to provide an inexpensive gold tooth polish available anyone wanting to avoid utilization of jeweler's buffing cloths in order to shine their dental gold.
(m) to provide an inexpensive gold tooth polish available anyone wanting to avoid utilization of jeweler's buffing machines in order to shine their partial plates, dentures or clip-on teeth containing dental gold.

Further objects and advantages will become apparent from a consideration of the ensuing description and drawings.

### SUMMARY

In accordance with this invention, gold tooth polish cleans and shines dental gold, and can also be utilized to shine dental platinum, without harmful chemicals. Gold tooth polish is categorized as a cosmetic by the Federal Food and Drug Administration (FDA), and is packaged in various sized tubes, jars and bottles.

The drawings show that this invention has evolved. This invention began as a mouthwash, toothpaste, and possible diamond shiner, and has evolved into a gold tooth polish.

### DRAWINGS—FIGURES

FIG. 1 shows the gold tooth polish packaged in a squeeze tube with a screw off cap.

FIG. 2 shows the gold tooth polish packaged in a squeeze bottle with a squeeze cap.

### DRAWINGS—REFERENCE NUMERALS

Not Applicable.

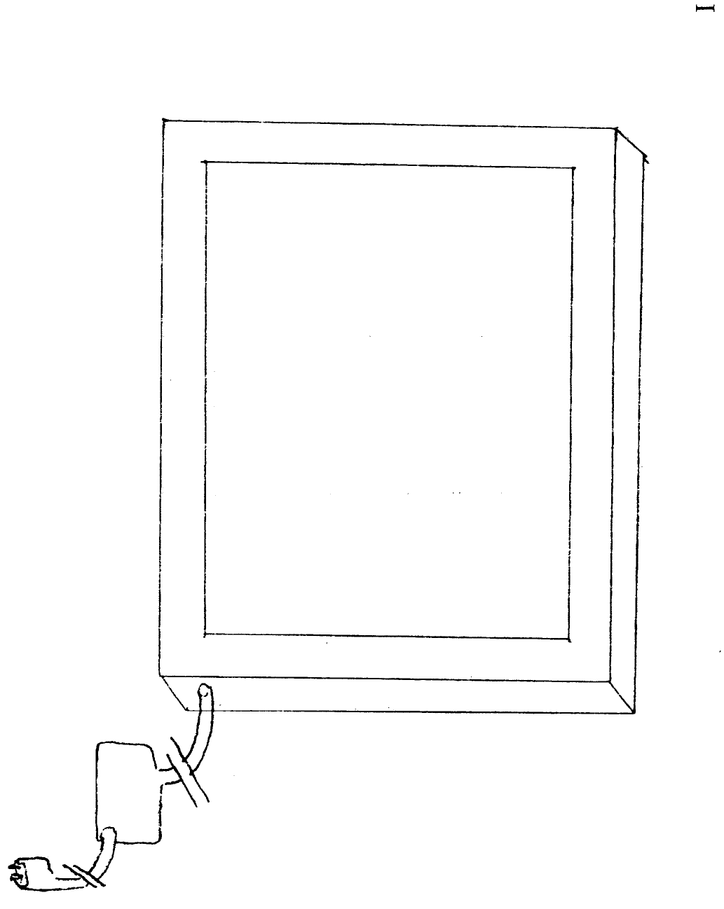

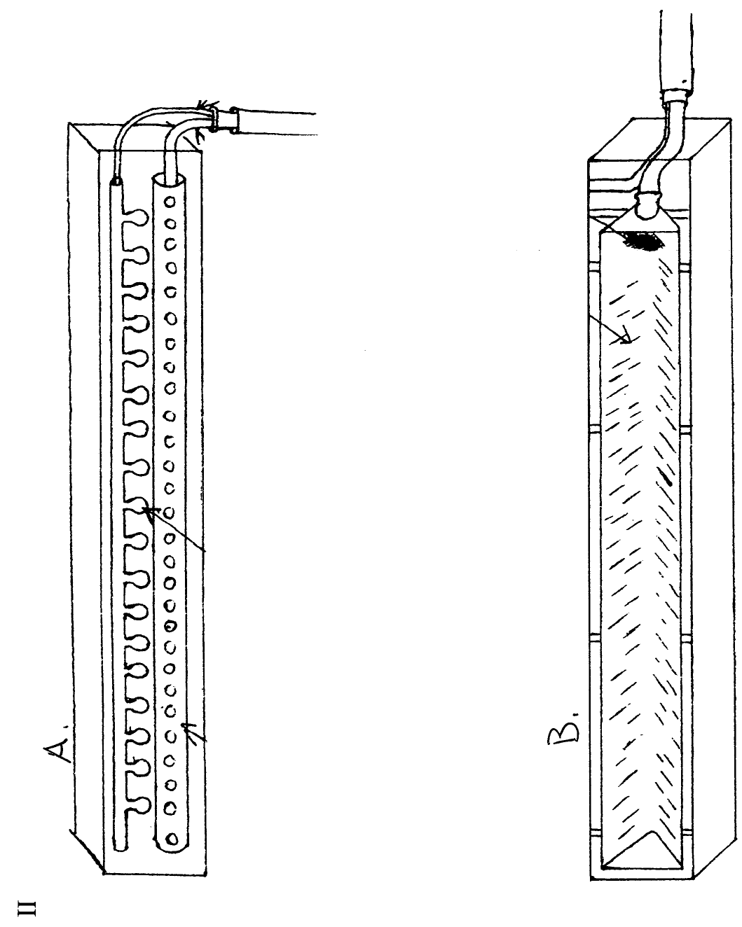

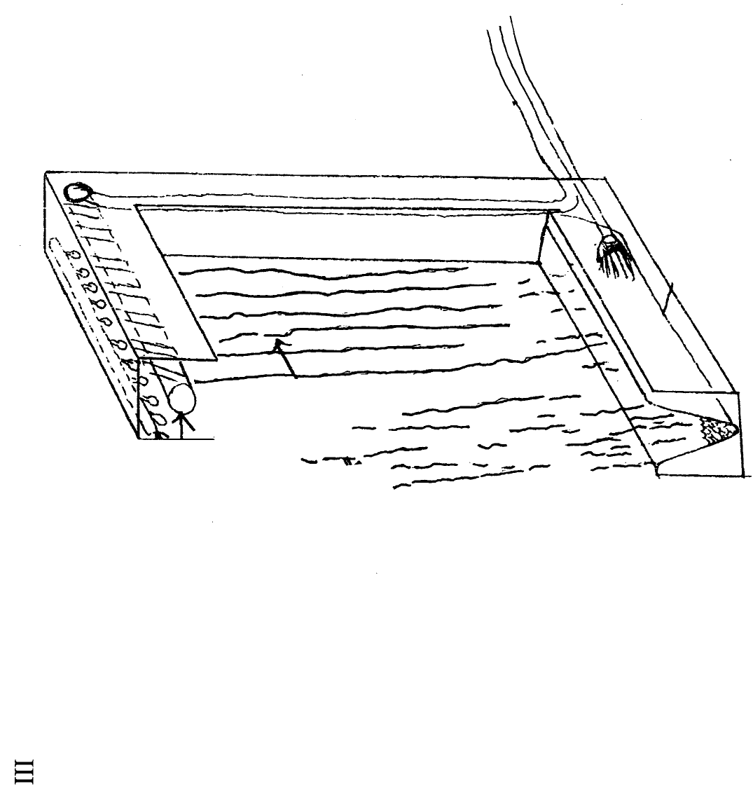

### DETAILED DESCRIPTION—PREFERRED EMBODIMENT—FIGS. 1 and 2

This invention, gold tooth polish contains the following ingredients:

Limestone dust, water, emulsifiers/gums, flavoring, including: peppermint, spearmint, cinnamon, lemon, lime, orange and licorice.

A preferred embodiment of the packaging of the gold tooth polish is illustrated in FIG. 1 and FIG. 2. As shown in FIG. 1, the gold tooth polish compound is placed into a tubular container, which is sealed at one end, and a fine ribbed lined closure/cap is present for closure at the other end until the product is utilized.

As shown in FIG. 2, the gold tooth polish compound is placed into a stand-up squeeze bottle with a removal poly-top-fine ribbed spout closure.

### OPERATION—PREFERRED EMBODIMENT—FIGS. 1 and 2

Machine grind down limestone dust into a fine powder, then add water, emulsifier and flavoring.

The ingredients of the gold tooth polish are mixed together in a sterile mixing container with an automated professional mixer to form a beige or tan pasty substance similar in appearance to a toothpaste, however, a little thicker than a toothpaste.

The gold tooth polish compound is allowed to sit for 48 hours to ascertain the final compound is double checked for firmness, coloring and flavor.

The gold tooth polish compound is then placed into sterile containers including the FIG. 1 tubular container and the FIG. 2 stand up bottle.

Accordingly, when ready to utilize the FIG. 1 container, the fine ribbed lined closure/cap is removed from the tubular container, and the gold tooth polish is squeezed from the tube onto a clean cloth or cotton swab. After each usage, the fine ribbed lined closure/cap is replaced onto the tubular container until the next usage.

Accordingly, when ready to utilize the FIG. 2 container, the spout of the poly-top fine ribbed closure is lifted and the gold tooth polish is squeezed out onto a clean cloth or cotton swab. After each usage, the spout of the poly-top fine ribbed closure is simply closed until the next usage.

### DESCRIPTION—ALTERNATIVE EMBODIMENT—FIGURES.

Not Applicable

### OPERATION—ALTERNATIVE EMBODIMENT—FIGURES

Not Applicable

### CONCLUSION, RAMIFICATIONS, AND SCOPE

Accordingly the reader will see that, the gold tooth polish, can clean as well as shine dental gold and platinum on natural teeth with inlays or crowns, as well as on the dental gold or platinum teeth of partial plates, dentures and clip-on teeth. Additionally, the gold tooth polish has additional advantages, and is useful to:
anyone who has suffered injuries to their natural teeth due to accidents, and either lost natural teeth or damaged natural teeth, repairing or replacing the loss or damage with dental gold or platinum.
anyone who has suffered dental disease and decay, and as a result has lost some of their natural teeth or tooth surfaces, repairing or replacing the loss or damage with dental gold or platinum.
entertainers who choose to enhance their physical image and facial appearance by adorning their teeth with gold or platinum, which emits gleam and shine to their fans.
young people who choose to enhance their physical appearance in order to attract and keep friends and the opposite sex by adorning their teeth with shining and sparkling gold or platinum teeth.
anyone who is a fan of any entertainers who chooses to copy their role models and idols by adorning their teeth with gold or platinum as a tribute to their favorite entertainers.

While the above description contains many specificities, these should not be construed as limitations on the scope of the gold tooth polish, but as exemplifications of the presently preferred embodiments thereof Many other ramifications and variations are possible within the usage of the gold tooth polish. For example, the gold tooth polish was first tested on precious metal household items, including teapots.

Thus the scope of the invention should be determined by the appended claims and their legal equivalents, and not by the examples given.

1. A material comprising a mixture of ground calcium carbonate (limestone dust) water, emulsifiers/gums, flavoring, including: peppermint, spearmint, cinnamon, lemon, lime, orange and licorice, whereby a paste for polishing dental gold and dental platinum will be provided.

2. A method for cleaning and polishing dental gold and dental platinum which:
(a) is safe for human consumption in the mouth and oral cavity.
(b) can be utilized on dental gold and dental platinum found on the natural teeth of humans with gold inlays, gold crowns or platinum crowns.
(c) can be utilized on dental gold and dental platinum found on the teeth of partial plates.
(d) can be utilized on dental gold and dental platinum found on the teeth of dentures.
(e) can be utilized on dental gold and dental platinum found on clip on teeth.
